(19) United States
(12) Patent Application Publication
(10) Pub. No.: US 2011/0225482 A1
(43) Pub. Date: Sep. 15, 2011

(54) MANAGING AND GENERATING CITATIONS IN SCHOLARLY WORK

(75) Inventors: KWAN-HO CHAN, Singapore (SG); VEDVYAS JAYARAGHAVENDRAN, Singapore (SG)

(73) Assignee: WIZPATENT PTE LTD, Singapore (SG)

(21) Appl. No.: 13/047,649

(22) Filed: Mar. 14, 2011

Related U.S. Application Data
(60) Provisional application No. 61/313,803, filed on Mar. 15, 2010.

(51) Int. Cl. G06F 17/24

(52) U.S. Cl. 715/207

(57) ABSTRACT

A method of managing and generating citations in word processing software using hyperlinks to represent in-text citations and bibliographic citations in which the hyperlinks provide the means to locate the corresponding bibliographic data for generating in-text citations and bibliographic citations in accordance with a desired citation style.

### CROSS-REFERENCE TO RELATED APPLICATIONS

This application is based upon and claims priority to U.S. Provisional Patent Application No. 61/313,803, filed on Mar. 15, 2010, entitled “Methods for Managing and Generating Citations in Scholarly Work” which is incorporated herein by reference.

### BACKGROUND OF THE INVENTION

1. The Field of the Invention

This application relates to the field of word processing software, and more particularly, to a method and system for generating and displaying citations in word processing software.

2. The Relevant Technology

Most scholarly writings are carried out on word processing software such as Microsoft® Word from Microsoft® Corporation, OpenOffice.org™ from Sun Microsystems® Inc., Google Docs™ from Google® Inc. and Zoho® Writer from Zoho® Inc. Authors of scholarly works often refer to the works of others in their writings to acknowledge the source of a quotation or a paraphrase of a source's ideas. Such references to the works of others are generally known as citations. The most commonly cited works are published journal articles. Research articles published in reputable journals are often peer reviewed by others who are expert in the same field. There are several categories of item types that are cited in scholarly writings including theses, books, web pages, and newspaper articles. The intent of citations is to correctly attribute other authors as the source of the information. The citation normally contains sufficient detail so that the reader is able to uniquely identify and retrieve the referenced article.

Publishers often require authors to format citations in accordance with specific guidelines generally known as citation styles. For each citation style, the guidelines specify how citation for each item type is to be formatted. There are many official guidelines on citation styles put forth by various organizations and publishers. MLA (Modern Language Association) style is most commonly used to cite sources for the liberal arts and the humanities. The US National Library of Medicine (NLM) provides citation styles that are commonly used by journals in life sciences and medicine. Organizations such as the American Psychological Association (APA) and the Institute of Electrical and Electronics Engineers (IEEE) have developed their own citation styles and these citation styles have been adopted by many scientific and technical journals. Some journals use their own citation style derived from well-known existing citation style such as the Harvard style and the Vancouver style. If an article submitted to a journal is rejected for publication, the author may have to reformat the citations on re-submission to a different journal which may require a different citation style.

Most modern reference management software such as EndNote® (Thomson Reuters®) provides automatic generation of citations in accordance with a selected citation style. EndNote's “Cite While You Write” feature inserts EndNote® commands into Microsoft® Word's Tools menu to give user direct access to users' references inside EndNote® while writing in Microsoft® Word. The “Cite While You Write” commands enable EndNote® to do citation formatting inside Microsoft® Word. EndNote® uses a type of embedded fields as disclosed in U.S. Pat. No. 5,552,982 for insertion and formatting of citations.

Research and scientific writing often involve multiple collaborators. Not all collaborators necessarily use the same word processing software. Software companies recognize this issue and have made the documents produced by one software to be interoperable with different word processing software. A Microsoft® Word document contains, in addition to the raw text created by the author, also contain certain proprietary encoding to define the formatting of the text. Such a document file created using Microsoft® Word will have a file extension of doc or docx. Word processing software from OpenOffice.org™ (Oracle Corporation) is capable of opening a Microsoft® Word document file. After extracting the text information and translating Microsoft® Word's formatting information to the OpenOffice.org™ encoding format, the document will be displayed by the OpenOffice.org™ software in the same format as was originally created in Microsoft® Word. The user can edit this document inside the OpenOffice.org™ word processing software and then save it either in native OpenOffice.org™ word processing software format with an odt file extension or in Microsoft® Word format with a doc file extension.

Many word processing software ensure that during import or export of document file, encoding for text formatting are faithfully translated for interoperability amongst the major word processing software. However, citations inserted into a document (e.g., created by Microsoft® Word using Endnote's “Cite While You Write” command) will not be correctly converted into corresponding citations when opened in OpenOffice.org™ word processing software. This lack of interoperability is due to the use of proprietary “fields” that are specific to Microsoft® Word.

Fields in a document-processing environment as disclosed in U.S. Pat. No. 5,552,982 are placeholders embedded within a stream of text. Each field is delineated by unique beginning and ending field characters, enclosing a field keyword, one or more field arguments, a separator field character (“|”) and a field result. When a field is encountered in a document, the keyword and arguments are parsed and field-specific functions are invoked through a look-up table that is indexed by the keyword. Field results are generated based on field arguments. The field results are displayed in the position occupied by the placeholders. U.S. Pat. No. 5,552,982 disclosed means whereby fields may be displayed in a result mode or field code mode. U.S. Pat. No. 5,552,982 also discloses a single mechanism for handling all fields, wherein a field specific algorithm that is invoked by the generic field mechanism defines the specific behavior of a field. Because there is no common field specific function between different word processing software, the fields cannot be ported directly from one software to another to produce the same field results and be displayed correctly.

Online word processors such as Google Docs™ and Zoho® Writer are based on HTML documents. HTML documents do not support the implementation of fields as taught by U.S. Pat. No. 5,552,982. Moreover, there is no common set of fields that would work for all word processors.

In general, a citation comprises of one or more in-text citations and a corresponding bibliographic citation containing bibliographic items for each in-text citation. The bibliographic citation is usually appended at the end of the main body of the writing as a bibliographic section with section titles such as “References”, “Cited Work” or “Bibliography.” The bibliographic citation starts with a bibliographic section title followed by one or more bibliographic items. Each bibliographic item contains sufficient information such as the authors' names, title of the article, the publisher, the page number and the date of publication so that the readers of the article are able to locate the cited work. FIG. 1 shows an excerpt 1a from a scientific publication together with a corresponding bibliographic citation 2a. FIG. 1 serves as an example of how citations are formatted in accordance with a standard citation style generally known as NLM Citation Style.

Referring to FIG. 1, citation for this example excerpt has in-text citations 11a, 12a, 13a and a corresponding bibliographic citation 2a with a bibliographic section title 20a. NLM Citation Style dictates that the in-text citations 11a, 12a, 13a be displayed as one or more numbers enclosed in brackets embedded in the flow of the text. The number(s) enclosed in brackets (11a, 12a, 13a) points to the bibliographic items 21a, 22a, 23a respectively. In this example, the numeral 1 in the in-text citation 11a points to bibliographic item 21a as the source of information for the phrase “loss of eye and brain structures” preceding the in-text citation 11a. Each bibliographic item (e.g., bibliographic item 21a) has a number of bibliographic parts consisting of a number part 210a, an author part 211a, a title part 212a, a journal name part 213a, a publication date part 214a, a volume part 215a, a series part 216a and a page number part 217a.

FIG. 2 shows the same excerpt 1b as in FIG. 1 together with a corresponding bibliographic citation 2b with a bibliographic section title 20b, formatted in accordance with APA citation style. The bibliographic citation 2b comprises the bibliographic section title 20b and a list of bibliographic items 21b, 22b and 23b. In this citation style, the in-text citations 11b, 12b, 13b are formatted as the authors' surnames followed by the year of publication, separated by commas and enclosed in brackets. Each of the in-text citations 11b, 12b, 13b points to its corresponding bibliographic items 21b, 22b, 23b respectively. For APA citation style, the bibliographic parts comprise of an author part 211b, a title part 212b, a journal name part 213b, a publication date part 214b, a volume part 215b, a series part 216b and a page number part 217b.

Citation style dictates how the in-text citations and the bibliographic citations are formatted and displayed. The citation style includes rules for punctuations, separators between texts, prefixes, suffixes and may also include font style for text. The citation style also includes rules as to what bibliographic parts are to be displayed and the sequence of appearance of the bibliographic parts. In many scholarly publications, in particular peer-reviewed publications, journal articles are the most commonly cited items. Other item types include but not limited to books, thesis, proceedings of scholarly conferences, technical reports and web pages. The citation style rules are specific for each item type. For example in most citation styles for journal articles, the page number part is required but the page number is not required if a web page is cited. The page number is not required for web page citation as page number is not relevant for web pages.

The World Wide Web Consortium (W3C) is the main international standards organization for the World Wide Web. The intent of this organization is to develop technical specifications and guidelines by consensus to facilitate compatibility in the implementation of technology for the World Wide Web. HTML is the most successful document markup language due in part to compliance to the W3C's HTML specifications by software developers, webmasters and users in general. The descriptions and definitions of HTML terms used here generally conform with the meaning from the official W3C's HTML specifications Version 4.01.

HTML document is a type of document that can be displayed as web pages on a computer screen by software applications, such as web browsers. Modern word processing software such as Microsoft® Word and OpenOffice.org™ can also open HTML documents for editing. Online applications like Google Docs™ and Zoho® Writer also have capabilities to format and edit HTML documents online. Web browsers from different operating systems such as Window OS, Mac OS and Linux can all open HTML documents and display the HTML document as web pages.

HTML documents are made up of HTML elements. FIG. 3 illustrates one generic form of an HTML element 3. In general, an HTML element 3 comprises an opening tag 30 and a closing tag 35 enclosing the element content 34. The tags are composed of a tag name 31 enclosed in angle brackets (e.g., <tagname>). The closing tag 35 is distinguished from the opening tag by a forward slash (/) preceding the tag name 36. Element attributes 32, 33 provide information about the element and are specified within the opening tag 30 usually as a name-value pair. By standard convention, the name is separated from its associated value by an equal sign (=) and attribute values are enclosed in quotes. When there is more than one attribute in the opening tag 30, the element attributes 32, 33 are separated by one or more spaces. Variations of the above description of HTML elements are well known to those skilled in the art and are documented in the official publications of the World Wide Web Consortium.

One form of element content 34 is the text to be rendered on the computer screen. Thus when a web browser application encounters an element such as, <FONT SIZE=“1”>This is an example of the smallest font.</FONT>

in an HTML document, the text “This is an example of the smallest font.” will be rendered on the computer screen in font size 1. In addition to text, element content can also include images, videos, sound and other elements.

In 1994, Tim Berners-Lee saw the possibility of retrieving information over the Internet by defining in a standard fashion the physical addresses of resources which are retrievable using protocols already deployed on the Internet. For the purpose of this invention, resources comprise of electronic files, electronic documents, computer programs, data, source of information, the operators and operands of a mathematical equation, types of relationships, or numeric values. Uniform Resource Locator (URL) specifies where an identified resource is available and the protocol to retrieve the identified resource. Tim Berners-Lee discloses an early draft specification of a URL in a document in March 1994.

FIG. 4 is a schematic illustration of a URL 4. A URL is constructed out of a series of segments in a specific sequence as illustrated in FIG. 4. In the specification of a URL, the protocol for retrieving resources over the Internet known as scheme 41 is listed first followed by a colon. The double forward slash “//” following the colon is the common syntax for all schemes related to the Internet protocols. Enclosed between this double forward slash and the next forward slash is the authority segment 42. Following this single forward slash is the path segment 43. The question mark “?” separates the path segment 43 from the query segment 44. The hash symbol “#” is interposed between the query segment 44 and the fragment identifier segment 45. The fragment identifier segment 45 is an optional segment of a URL and is used to identify a portion of a resource for example a portion of a document. The query segment 44 can also be an optional segment of an URL.

FIG. 5 shows an example of a fully constructed URL 4a. The scheme 41a illustrated here in this URL example is the Hypertext Transfer Protocol (HTTP). The authority segment 42a consists of an optional user name and password 421a, a hostname 422a and an optional port number 423a. For the Internet, a hostname is a domain name assigned to a host computer. In the case when a user name and password is required, the “@” symbol is interposed between the user name and password 421a, and the hostname 422a.

Within the context of computing, the term “path” is meant to specify a unique location in a file system in the host computer of the desired resource. The path segment 43a in the context of the Internet is the path that points to the location of the desired resource on the host computer.

Query segment 44a, also known as “query string” to those skilled in the art, is made up of a series of field-value pairs. By standard convention the field-value pairs are separated from its associated value by an equal sign “=”. A series of field-value pairs are separated from each other by the ampersand “&” sign or by a semicolon. When a host computer receives a request from a client computer for a resource such as a query to a database, the information contained in the query string in the form of field-value pairs is passed as a query to the database. For example in FIG. 5, the HTTP request locates the database program 431a with file extension 432a named bbc.dtb in a host computer by navigating the path segment 43a to the “Friday” subfolder inside the “news” folder. By way of an example, the query string 44a is a query to a database for information on a company named “National” belonging to the “bank” category. For the information that is returned from this query, the portion relating to “interest rate” is identified by the fragment identifier segment 45a.

Hyperlinks are integral to the functioning of the World Wide Web. In the context of the Internet, hyperlinks are HTML elements generally known to those skilled in the art as “anchor elements” with the starting tag <a>. Hyperlinks can point to any resources on the Internet using the attribute href=“URL”. In general a hyperlink consists of three components, a URL, an element content and an element title with the following syntax: <a href=“URL” title=“Title”>Label</a>.

In an HTML document the text “Label” will be displayed usually as underlined text with a color different from the other text in the document. When the cursor hovers over the text “Label”, the cursor changes into a hand icon and when the cursor hover over the text “Label” for a predetermined length of time the element title appears as the text “Title.” Element title as described here is also known as “tool tip” or “screen tip” to those skilled in the art. In the context of hyperlinks, the term hyperlink label will be used interchangeably with the term element content as in general the element content for hyperlinks is generally text. The text rendered on the computer screen in accordance with the hyperlink label will be termed as the displayed label. Many types of word processing software including Microsoft® Word and OpenOffice.org™ will translate the hyperlinks in html documents into the corresponding encoding for hyperlinks in the respective word processing software. Likewise hyperlinks in the native word processing format are translated correctly as html hyperlinks when exported as an html document. Developers of word processing application have taken great care to ensure interoperability of hyperlinks because of the ubiquitous use of hyperlinks in html documents and in word processing documents.

Hypertext Transfer Protocol (HTTP) is a fast stateless information retrieval protocol for the Internet most commonly using the TCP/IP platform. Resources to be accessed are located using URLs. A typical HTTP session is a request/response transaction in which the client computer initiates a request for the desired action to be taken on the identified resource, eventually receiving the result of the request from the server. When HTTP is combined with secure sockets layer (SSL) and/or transport layer security (TLS) protocols to provide encryption and secure identification of the server, it is known as Hypertext Transfer Protocol Secure (HTTPS). In the implementation of this invention, HTTP or HTTPS can be used interchangeably depending on the level of security desired.

Add-ons are optional computer programs that, if combined with the host program, will supplement or enhance the functionalities of the host program. Third party software developers usually provide such add-ons. Add-ons include plug-ins and extensions, well understood by those skilled in the art. The add-ons by themselves are usually non-functional. The host program provides means for the add-ons to register with host program.

Most computer software, for example a generic word processing software of which the user interface 5 is shown in FIG. 6, has a menu bar area 51 and a toolbar area 52. A toolbar in a graphical user interface is a set of customizable buttons, icons, or menus that triggers predetermined series of action by the host program or by the add-ons. In Microsoft® Word 2007, the functionalities of the menu bar and toolbar are combined as a “Ribbon”.

### BRIEF DESCRIPTION OF THE DRAWINGS

Various embodiments of the present invention will now be discussed with reference to the appended drawings. It is appreciated that these drawings depict only typical embodiments of the invention and are therefore not to be considered limiting of its scope.

FIG. 1 and FIG. 2 are examples of excerpts from a scientific publication showing examples of in-text citations and bibliographic citations formatted in two different citation styles.

FIG. 3 illustrates the syntax of a generic form of an HTML element.

FIG. 4 is schematic of a URL construct and its component parts.

FIG. 5 is an example of a fully constructed URL.

FIG. 6 is an example of the user interface of a generic word processing software.

FIGS. 7-10 illustrate an example sequence of events as it appears on the user interface of generic word processing software when citations are inserted into the document.

FIGS. 11 and 12 illustrate the process of selecting and applying a citation style as it appears on the user interface of a generic word processing software.

FIG. 13 is a schematic of an insert function that implements the insert citation part of this invention.

FIG. 14 is a schematic of the item selection function that implements the display, item selection and generation of information used for forming in-text citations.

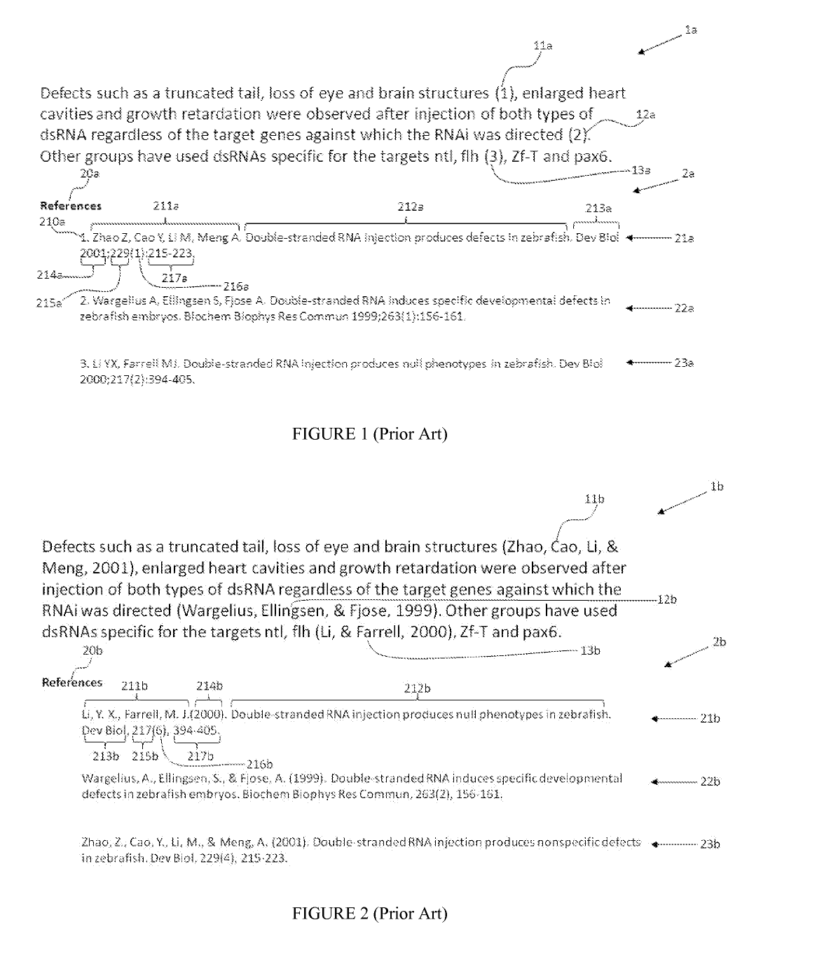

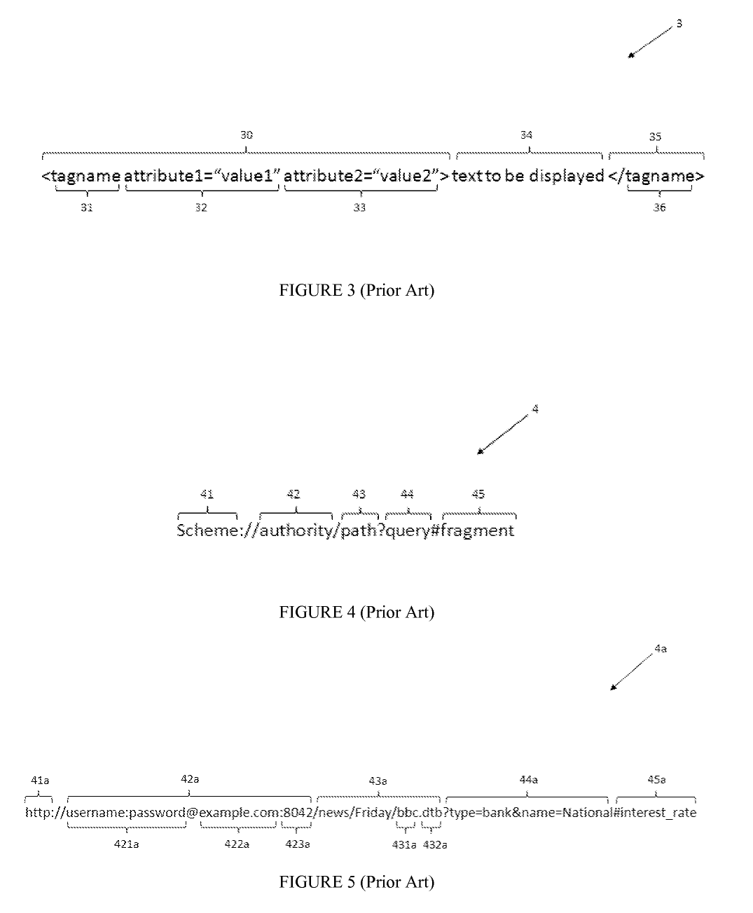

### DETAILED DESCRIPTION

Embodiments of the present invention relate to methods, computer program products and/or systems that manage and generate citations for many different types of writings including scholarly writings. The drawings and accompanying description are merely exemplary. Accordingly, the scope of the present invention is not intended to be limited by the examples discussed herein.

Embodiments of the present invention provide an interoperable method of managing and generating citations amongst different types of word processing software.

The following discussion now refers to a number of methods and method acts that may be performed. It should be noted, that although the method acts may be discussed in a certain order or illustrated in a flow chart as occurring in a particular order, no particular ordering is necessarily required unless specifically stated, or required because an act is dependent on another act being completed prior to the act being performed.

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media. Computer-readable media that carry computer-executable instructions are transmission media. Thus, by way of example, and not limitation, embodiments of the invention can comprise at least two distinctly different kinds of computer-readable media: computer storage media and transmission media.

Computer storage media includes RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry data or desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks (e.g. cloud computing, cloud services and the like). In a distributed system environment, program modules may be located in both local and remote memory storage devices.

A computer network is a collection of computers and devices interconnected by communications channels that facilitate communications and sharing of resources and information among the interconnected computers and devices. Computer networks are identified by their scale and scope, such as Local Area Network (LAN) and Wide Area Network (WAN). The Internet is a global system of interconnected computer networks most commonly using the TCP/IP communication protocol. These terms are well known to those skilled in the art. The terms network, computer network and the Internet are used interchangeably and the present invention is applicable to all of these configurations.

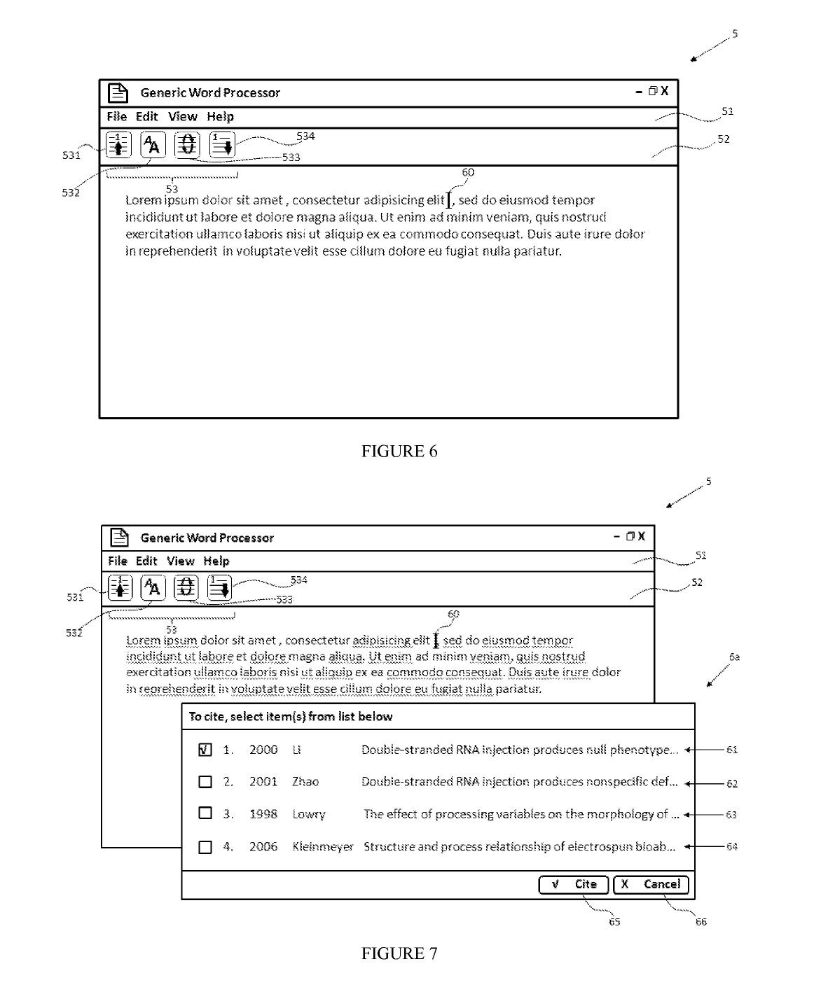

For the purpose of describing one embodiment of this invention, the term “citation add-ons” refers to add-ons provided for by this invention for the purpose of managing and generating citations. In one embodiment, the invention provides citation add-ons to be installed in existing word processing software such as Microsoft® Word, OpenOffice.org™, Google Docs™ and Zoho® Writer for the purpose of managing and generating citations. This invention is applicable to any rich text documents including but not limited to HTML documents. A user interface 5 of a generic word processing software as shown in FIG. 6 is meant to be an illustration and is not meant to be limiting of the invention or meant to be limited to a specific word processing software or a specific operating system. It will be obvious to those skilled in the art that this invention is applicable to any word processing software running in any operating system including without limitation desktop applications and online applications. According to this invention, the citation add-ons provide for codes to manipulate HTML elements, hyperlinks or other encoding methods to represent in-text citations and bibliographic citations. More particularly, processed and formatted element contents are displayed as in-text citations or as bibliographic citations.

In one embodiment, the HTML elements are hyperlinks. The element content of the hyperlinks is displayed as in-text citations or as bibliographic citations. An in-text hyperlink is a hyperlink in which the element content is the appropriately formatted text to represent in-text citation in accordance with a desired citation style. In the context of in-text hyperlink, an in-text label is the element content containing the formatted text representing the in-text citation. An in-text URL is the URL of an in-text hyperlink. An in-text title is an element title of an in-text hyperlink.

Similarly, a bibliographic hyperlink is a hyperlink in which the element content contains the text for a bibliographic citation that is appropriately formatted in accordance with a desired citation style. In general there is only one bibliographic hyperlink per document. In the case of books there can be multiple bibliographic hyperlinks with one bibliographic hyperlink for each chapter of the book. A bibliographic URL is the URL for a bibliographic hyperlink. In the context of bibliographic hyperlink, a bibliographic label is the element content containing the formatted text representing the bibliographic citation. A bibliographic label includes a section title and a list of bibliographic items derived from the list of in-text hyperlinks formatted in accordance to the desired citation style. The bibliographic hyperlink is inserted at a defined point in the document. The location of the bibliographic hyperlink in the document may be dictated by the citation style, by the requirement of the publisher or by generally accepted convention. A bibliographic title is an element title of a bibliographic hyperlink pertaining to the selected item. In an alternative embodiment, the bibliographic title can be configured to display any desired message (e.g. an advertisement) or, alternatively, it could be left blank.

The installation of a citation add-on in the host program creates a series of command buttons 531, 532, 533, 534 in the tool bar area 52 of the host program as illustrated in FIG. 6. For the convenience of the user of the software, the command buttons 531, 532, 533, 534 are grouped together as a citation toolbar 53. Clicking on any of the command buttons provided for by the add-ons will invoke a predetermined series of actions. These invoked series of actions can either be provided for by the add-ons or provided for by the host program or a combination thereof. Other equivalent methods of triggering a series of predetermined action provided for by the add-ons will be obvious to those skilled in the arts by practicing this invention.

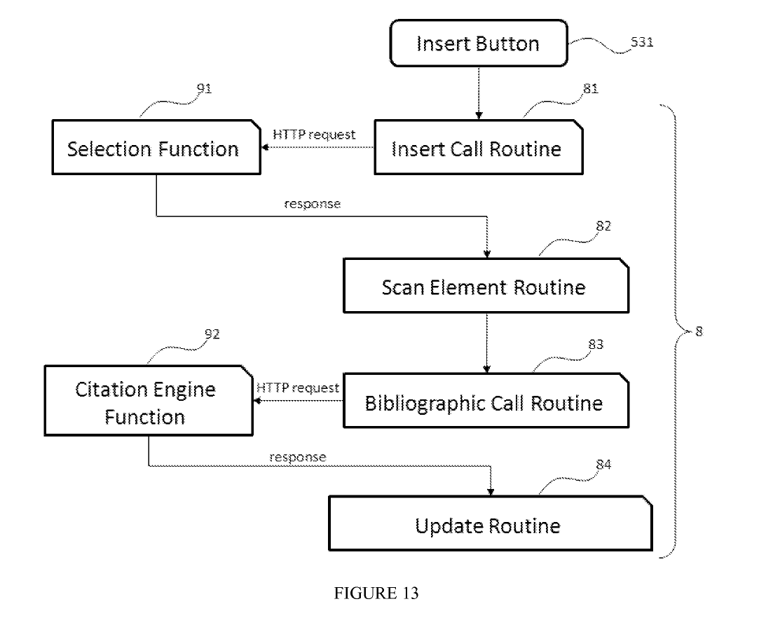

The following is a description of one embodiment of the citation add-on. Referring to FIG. 13, the citation add-on has an insert function 8 comprising of four code segments namely an Insert Call Routine 81, a Scan Element Routine 82, a Bibliographic Call Routine 83 and an Update Routine 84. Clicking on the insert button 531 initiates execution of the four code segments of the insert function 8 in the sequence depicted in FIG. 13. The Insert Call Routine 81 executes an HTTP request for a Selection Function 91 residing on a server in the Internet. The Selection Function 91 allows the user to select the desired items to be cited. The details of the Selection Function 91 are further described later. The response to the HTTP request initiated by the Insert Call Routine 81 comprises the generation of one or more in-text triplets. Each in-text triplet consists of an in-text URL, an in-text label and an in-text title pertaining to the selected item. In an alternative embodiment, the in-text title can be configured to display any desired message (e.g. an advertisement) or, alternatively, it could be left blank. An in-text triplet can be used to construct a hyperlink to represent an in-text citation. Other forms of encoding the information contained in an in-text triplet are also possible.

An example of an in-text URL in response to the HTTP request is as follows.

https://www.wizfolio.com/?flag=1 &type=1&ver=3&ItemID=2E171Y&UserID=53X49& AccessCode=F799BFC25&OptionalSuff=
In the above example the field-value pair “flag=1” indicates that this URL relates to in-text citation. The field-value pair “type=1”, indicates that the type of item this in-text citation represent is a journal article. A different number for example “type=2” may indicate that the type of time is a book. The field-value pair “ver=3” indicates that the version of the citation add-ons that was used. The field-value pairs “UserID=53×49” and “ItemID=2E171Y” are identifiers relating to the user and the specific item for this in-text citation respectively. These identifiers are useful for retrieving data (e.g., bibliographic data from a database). The in-text URL, can provide links to the corresponding bibliographic data for the selected stored reference items. Additionally, bibliographic data of the selected item can also be embedded in the in-text URL (e.g., as field-value pairs in the query segment of the in-text URL). The name-value pair “AccessCode=F799BFC25” is an access code for giving permission to the user to retrieve bibliographic data for a specific item in a specific user's collection. The access code is generated at the time the item is created in the database of a user's account or alternatively it can be created by the Selection Function 91 when an item is selected by the user. The role of the access code in this invention is described later. To those skilled in the art, it will be apparent that additional name-value pair can also be included for example an optional attribute OptionalSuff. The in-text label and in-text title resulting from the Insert Call Routine 81 is in the form of a temporary in-text label and a temporary title respectively. The Insert Call Routine 81 then generates an in-text hyperlink for each of the selected items. The in-text hyperlinks are generated in accordance with the encoding for hyperlinks of the host software using values from the in-text triplets.

The Scan Element Routine 82 is next invoked to collect information on all the in-text hyperlinks in the document. The Scan Element Routine 82 scans the whole document for in-text hyperlinks to collect information contained within the in-text hyperlinks. Hyperlinks within the document are detected in accordance with the encoding for hyperlinks of the host program. The Scan Element Routine 82 identifies a hyperlink as an in-text hyperlink inserted by the Insert Call Routine 81 by recognizing certain predetermined characteristics of the URL of the in-text hyperlink such as the hostname within the in-text URL or one or more predetermined field-value pair(s) in the query segment of the in-text URL. As an alternative, the name-value pair within the opening tag of the hyperlink can be used as a flag for identifying a hyperlink as an in-text hyperlink. The Scan Element Routine 82 identifies each of the in-text hyperlinks, the sequence of appearance of the in-text hyperlinks and if there is intervening text between the sequential in-text hyperlinks. If there is no text intervening between two sequential in-text hyperlinks then the two in-text hyperlinks are considered as contiguous in-text hyperlinks. For the purpose of determining contiguous in-text hyperlinks, the term “text” here means any character including punctuations and spaces. Each citation style has its own rules with respect to how in-text citations are formatted for two or more contiguous in-text citations. For example, in APA format, three contiguous in-text citations are formatted as (Lee, 2007; Johnson, 1997; Rock, 1994) whereas in one form of NLM citation style, the three in-text citations are represented as (1-3). A group of contiguous in-text hyperlinks forms an in-text citation block. The information pertaining to in-text citation block is used for the proper formatting of citations in accordance to specific citation style.

The Scan Element Routine 82 also identifies a particular hyperlink as a bibliographic hyperlink by recognizing a predetermined element attribute flagging that hyperlink as a bibliographic hyperlink. Additional element attributes include name-value pair for version of citation add-on, name-value pair for user identification and name-value pair for the selected citation style. An example of a bibliographic URL is as follows.

https://www.wizfolio.com/?flag=2&ver=3&UserID=5S$4AA&StyleName=APA
In the above example, the name-value pair “flag=2” indicate that this hyperlink is a bibliographic hyperlink. The name-value pair “ver=3” is the version of citation add-on. The name-value pair “UserID=5S$4AA” is used to identify the user. The name of the citation style selected is APA as given by the name-value pair “StyleName=APA”. In addition to a default citation style, means can be incorporated to make the citation style selectable by the user. Further means can also be incorporated to make the citation style modifiable by the user.

Citation packet is a packet of information comprising the information embedded in all the in-text hyperlinks, information embedded in the bibliographic hyperlink, sequence of the hyperlinks and in-text citation blocks. Bibliographic Call Routine 83 initiates an HTTP request to a host computer on the Internet by sending the citation packet to the Citation Engine Function 92 (FIG. 13), a resource potentially residing in the target host computer. Based on the information in the citation packet, the Citation Engine Function 92 will retrieve bibliographic data for each in-text citations using userID, itemID and accessCode to generate updated in-text labels and updated bibliographic labels in accordance to the selected citation style and return these updated labels as part of the citation packet to the client computer. The Update Routine 84 replaces the existing element content in each of the in-text hyperlinks and the bibliographic hyperlink with the updated in-text labels and the updated bibliography label.

The response to the HTTP call of Bibliographic Call Routine 83 includes the updated element contents of the all the in-text hyperlinks and the bibliographic hyperlink. The Update Routine 84 then refreshes the documents with the updated element contents for all the in-text hyperlinks and the bibliographic hyperlink.

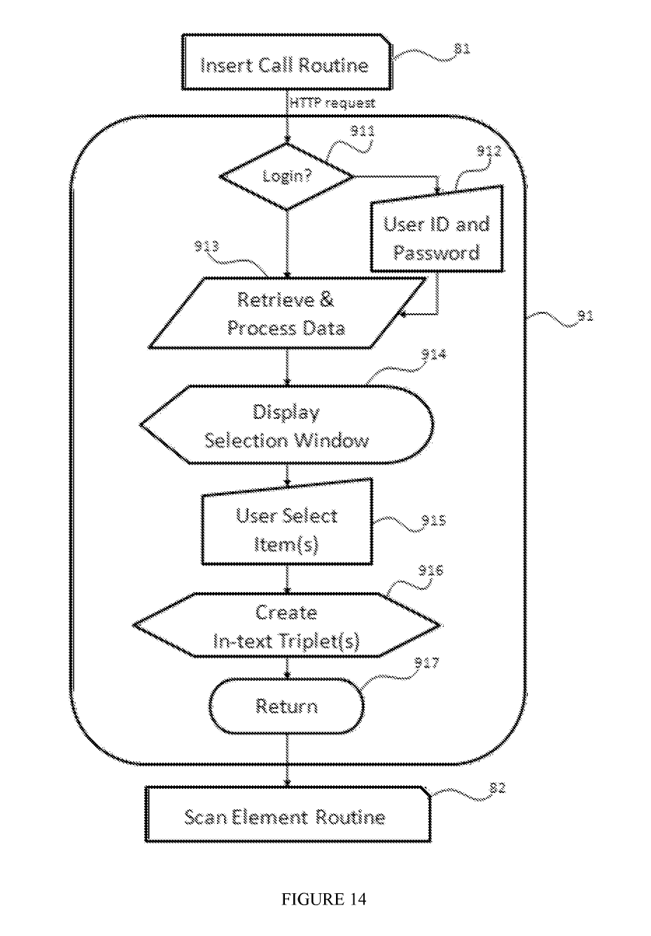

To insert a citation into the document, the user positions the cursor 60 in the user interface to a desired position in the document as depicted in FIG. 6. On clicking the insert button 531, the Insert Call Routine 81 is invoked and an HTTP request is initiated for the Selection Function 91 on a server on the Internet. FIG. 14 is a schematic representation of a series of actions carried out by Selection Function 91. The request is checked 911 to determine if the user is authorized to access the Selection Function 91. If the user does not have authorization, the user is asked to login with user identification and password 912. Once logged in, data is retrieved and processed 913 to be displayed 914 to the user in a selection window. By way of an example, the data retrieved is a set of bibliographic data in user's collection. The bibliographic data is presented to user in a selection window 6a. The selection window 6a as depicted in FIG. 7 is a list of bibliographic items 61, 62, 63 64 from which the user can select one or more items. In one embodiment, the display window 6a is a web page. This list of bibliographic item(s) is an abbreviation of the retrieved bibliographic data displaying only sufficient information such as the year of publication, author and a partial title to enable the user to easily identify and select the desired item(s). After selecting the desired item(s) to be cited 915, the user can click on cite button 65. The Selection Function 91 then generates one or more in-text triplets 916 for each of the selected item(s). At this stage, a dummy in-text label is generated for the in-text triplet, as the in-text label is dictated by the final desired citation style which is yet to be determined. The response to the HTTP request Insert Call Routine 81 returns 917 the in-text triplets pertaining to the selected items. The selection process can be aborted by clicking on the cancel button 66.

For the purpose of explaining the function of the access code, we use the example of two users collaboratively working on a single document and each user cites from their own database of bibliographic data. When an item is selected by a first user using the Selection Function 91, the right to access this item is determined by the unique access code of selected item belonging to the first user. As previously described, the access code is embedded in the in-text URL of the in-text triplet. The in-text URL as previously described also contains identification of the first user and the item identification of the selected item whose bibliographic data resides in a database controlled by the first user.

One embodiment of this invention comprises the use of hyperlinks to represent in-text citations and bibliographic citation in which the hyperlinks provide the means to locate the appropriate bibliographic data and citation style for generating in-text citations and bibliographic citations. The hyperlinks themselves may not contain the full set of bibliographic data used to generate in-text citation and bibliographic citation for all citation styles. The in-text labels and bibliographic label contain only a subset of the bibliographic data sufficient for the prevailing citation style. After the first user inserted certain citations into the document, he sends it to the second user. The second user opens the document created by the first user to edit. When he chooses a citation style different from the first user, the Citation Engine Function 92 will retrieve bibliographic data for each of the citations cited by first user from the database controlled by the first user. The access codes give permission for the second user to access specific items in the first user's database. The access codes are item-specific and, therefore, do not give permission for the second user to have unlimited access to all data in a database of the first user.

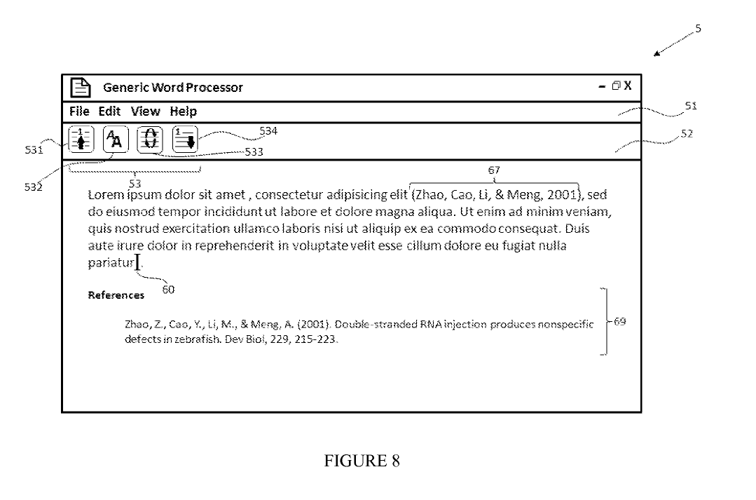

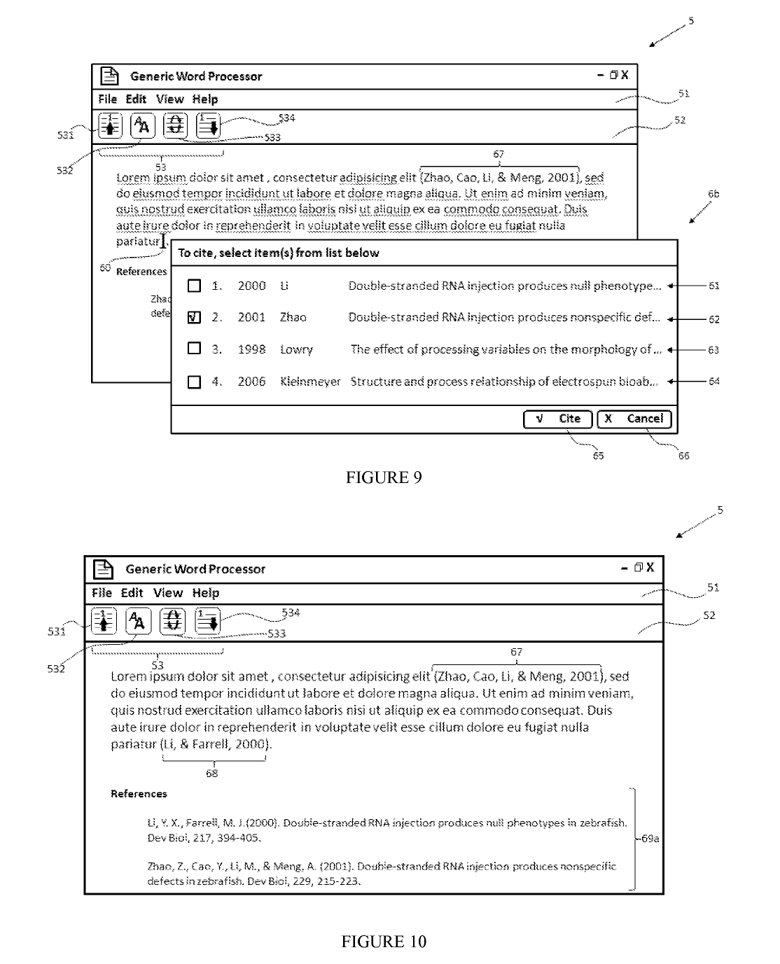

FIG. 8 is the result of the insertion of one citation with the in-text label of the in-text hyperlink displayed as an in-text citation 67 and the bibliographic label of the bibliographic hyperlink displayed as a bibliographic citation 69. In FIG. 8, the cursor 60 is positioned at a different location on the user interface compared to that in FIG. 7. On clicking the insert button 531, the selection window 6b is displayed as shown in FIG. 9. In this instance, item 62 is selected. On clicking the cite button 65, in-text citations 67, 68 and bibliographic citation 69a are generated as shown in FIG. 10.

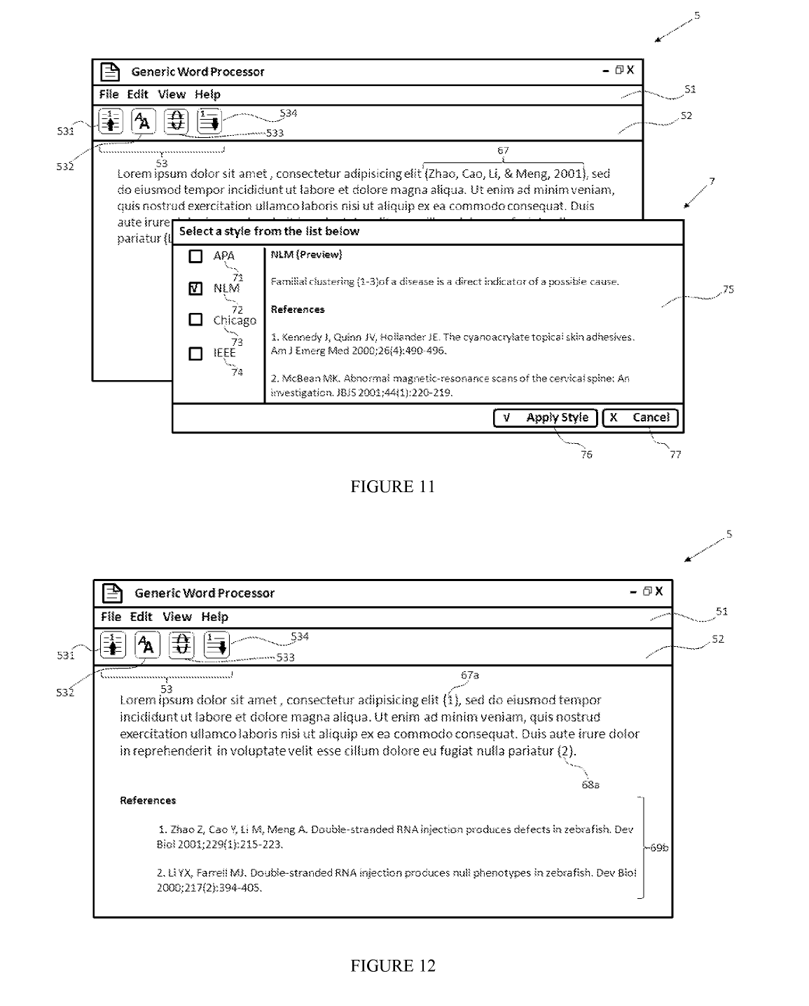

This invention provides a citation style button 532 which when clicked will open a choose citation style window 7 as shown in FIG. 11. On the left side of the choose citation style window 7 are selectable citation styles 71, 72, 73, 74 with check boxes. In the instance shown in FIG. 11, the NLM citation style is selected; a preview panel 75 shows examples of in-text citation and bibliographic citation for this citation style. On clicking the Apply Style button 76, the Scan Element Routine 82, Bibliographic Call Routine 83 and the Update Routine 84 are invoked sequentially to apply the selected citation style. The result is shown in FIG. 12 showing reformatted in-text citations 67a, 68a and reformatted bibliographic citation 69b. In a similar manner, when the refresh button 533 is clicked, the Scan Element Routine 82, Bibliographic Call Routine 83 and the Update Routine 84 are invoked sequentially using the existing citation style. The citation style selection process can be aborted by clicking on the cancel button 77.

This invention also provides a list bibliography button 534. Clicking on this button will invoke the Scan Element Routine 82 followed by the Bibliographic Call Routine 83. However in this instance, the Bibliographic Call Routine 83 will make a HTTP request for List Citations Function, a resource residing on a target host computer residing on the Internet. The List Citation Function processes the information contained in the citation packet transferred by the HTTP request. The List Citation Function abstracts all the information from the in-text hyperlinks and generates a bibliographic list to be displayed in a bibliographic list window. The bibliographic list window allows the user to select the desired item to be saved into a desired location controlled by the user such as a bibliographic database.

In FIG. 13, both Insert Call Routine 81 and Bibliographic Call Routine 83 make HTTP requests for resources on one or more host computers on the Internet. In another embodiment of this invention, the codes for Selection Function 91 and the Citation Engine Function 92 can be located on the same computer in which the word processing software resides. In yet another embodiment of the invention the codes embodying the functions of Selection Function 91 and Citation Engine Function 92 can be incorporated into the citation add-on or the host program or a combination thereof. In one embodiment, the Selection Function 91 retrieves data residing on a server on the Internet. In an alternate embodiment the data to be retrieved by the Selection Function 91 resides on the same computer in which the word processing software resides. In other words, the resources such as computer codes and data pertaining to HTTP requests are location independent.

In one embodiment of the invention, hyperlinks are used to represent in-text citation and bibliographic citation. In an alternative embodiment any HTML element with attributes and element content can be used to represent in-text citations and bibliographic citations.

In yet another alternative embodiment of the invention, the information pertaining to the bibliographic parts such as the author, title, volume, page number, date of publication and publisher can be directly embedded into an HTML element as name-value pairs or any other data encoding format well known to those skilled in the art such as XML and JSON. The element content to represent in-text citation is generated using the information from the embedded data in the HTML element.

We claim:

1. At a computer system comprising at least one processor and a memory, a method of managing and generating citations using hyperlinks, the method comprising:
receiving an indication from a user that one or more reference items are to be cited in a document at a specified point in the document;
displaying one or more stored reference items that are selectable by the user;
receiving a selection from the user indicating which one or more stored reference items are to be cited in the document;
generating an in-text hyperlink comprising one or more in-text triplets for each of the selected stored reference items, wherein each in-text triplet includes an in-text label in a specified citation style, an in-text title and an in-text uniform resource locator (URL); and
inserting the generated in-text hyperlink in the document at the user-specified point in the specified citation style.

2. The method of claim 1, wherein the in-text URL links to the corresponding bibliographic data for the selected stored reference items.

3. The method of claim 1, wherein the in-text hyperlink includes the bibliographic data for the selected stored reference.

4. The method of claim 3, wherein the in-text URL includes the bibliographic data for the selected stored reference.

5. The method of claim 1, wherein the in-text title includes information pertaining to the selected stored reference item.

6. The method of claim 1, wherein an access code is embedded in the in-text URL of the in-text triplet.

7. The method of claim 1, wherein the access code is verified to determine that the user has permission to access the reference.

8. The method of claim 1, wherein a field value in the in-text URL indicates the reference type of the reference.

9. The method of claim 1, wherein in-text hyperlinks within the document are generated in accordance with host program encoding for hyperlinks using values from the in-text triplets.

10. The method of claim 1, further comprising scanning for one or more predetermined URL characteristics of the in-text URL including at least one of a host name and a field-value pair in the query segment.

11. The method of claim 1, further comprising:
determining that two or more sequential in-text hyperlinks have no intervening text; and
indentifying the determined in-text hyperlinks as contiguous in-text hyperlinks.

12. The method of claim 11, wherein the in-text hyperlinks identified as contiguous are inserted into the document according to specific citation style rules for contiguous citations.

13. The method of claim 1, further comprising indentifying one or more hyperlinks as bibliographic hyperlinks, wherein the bibliographic hyperlinks comprise text for bibliographic citations that are appropriately formatted in accordance with the specified citation styles.

14. The method of claim 13, further comprising generating a citation packet which includes information corresponding to the information embedded in the in-text hyperlinks, information embedded in the bibliographic hyperlinks, a sequence of the in-text hyperlinks and in-text citation blocks.

15. The method of claim 13, further comprising implementing an update routine that replaces existing content in each of the in-text hyperlinks and bibliographic hyperlinks with updated in-text labels and updated bibliography labels.

16. The method of claim 13, wherein the bibliographic hyperlink links to specific citation styles.

17. The method of claim 15, further comprising inserting the generated bibliographic hyperlink in a predefined point in the document.

18. At a computer system comprising at least one processor and a memory, a method of managing and generating citations using hyperlinks, the method comprising:
receiving an indication from a user that one or more reference items are to be cited in a document at a specified point in the document;
displaying one or more stored reference items that are selectable by the user;
receiving a selection from the user indicating which one or more stored reference items are to be cited in the document;
generating a hyperlink comprising one or more in-text triplets for each of the selected stored reference items, wherein each in-text triplet initially includes a temporary in-text label, a temporary in-text title and an in-text uniform resource locator (URL);
scanning at least a portion of the document for other in-text citations in the document;
generating both an in-text label and an in-text title to replace the temporary in-text label and title using the in-text triplet of the hyperlink in a specified citation style, wherein the hyperlink URL links to the corresponding bibliographic data for the selected stored reference items; and
inserting the generated hyperlink at the user-specified point in the document.

19. The method of claim 15, wherein the displayed reference items are displayed in a window that comprises a web page.

20. The method of claim 16, wherein the web page comprises a list of abbreviated bibliographic items that include an abbreviated portion of the bibliographic data.

21. The method of claim 16, wherein two or more users are citing references using different word processors that implement different citation styles.

22. The method of claim 18, wherein an access code embedded in the in-text URL of the in-text triplet is used to verify that each user has permission to access the cited references.

23. A computer system comprising the following:
one or more processors;
system memory;
one or more computer-readable storage media having stored thereon computer-executable instructions that, when executed by the one or more processors, causes the computing system to perform a method for managing and generating citations using hyperlinks, the method comprising the following:
receiving an indication from a user that one or more reference items are to be cited in a document at a specified point in the document;
displaying one or more stored reference items that are selectable by the user;
receiving a selection from the user indicating which one or more stored reference items are to be cited in the document;
generating an in-text hyperlink comprising one or more in-text triplets for each of the selected stored reference items, wherein each in-text triplet includes an in-text label in a specified citation style, an in-text title and an in-text uniform resource locator (URL); and
inserting the generated in-text hyperlink in the document at the user-specified point in the specified citation style.
